(19) United States
(12) Patent Application Publication
(10) Pub. No.: US 2017/0277489 A1
(43) Pub. Date: Sep. 28, 2017

(54) IMAGE FORMING APPARATUS, MOBILE TERMINAL, IMAGE FORMING SYSTEM, AND NON-TRANSITORY COMPUTER READABLE MEDIUM STORING PROGRAM

(71) Applicant: FUJI XEROX CO., LTD., Tokyo (JP)

(72) Inventor: Akira Okamoto, Kanagawa (JP)

(21) Appl. No.: 15/238,764

(22) Filed: Aug. 17, 2016

(30) Foreign Application Priority Data
Mar. 24, 2016 (JP) 2016-059992

(51) Int. Cl. G06F 3/12

(52) U.S. Cl. CPC G06F 3/1238; G06F 3/1203; G06F 3/1292; H04B 5/0031

(57) ABSTRACT

Provided is an image forming apparatus including an authentication information reception unit that receives authentication information which is input by a user, an authentication information transmission unit that transmits the received authentication information to a mobile terminal of the user, an image data acquisition unit that allows the mobile terminal to perform authentication by collating the transmitted authentication information and authentication information, which is stored in the mobile terminal, and acquires image data from the mobile terminal in a case in which the authentication is successful, and an image forming unit that forms an image on a recording medium based on the acquired image data.

### CROSS REFERENCE TO RELATED APPLICATIONS

This application is based on and claims priority under 35 USC 119 from Japanese Patent Application No. 2016-059992 filed Mar. 24, 2016.

### BACKGROUND

### TECHNICAL FIELD

The present invention relates to an image forming apparatus, a mobile terminal, an image forming system, and a non-transitory computer readable medium storing a program.

### SUMMARY

According to an aspect of the invention, there is provided an image forming apparatus including: an authentication information reception unit that receives authentication information which is input by a user; an authentication information transmission unit that transmits the received authentication information to a mobile terminal of the user; an image data acquisition unit that allows the mobile terminal to perform authentication by collating the transmitted authentication information and authentication information, which is stored in the mobile terminal, and acquires image data from the mobile terminal in a case in which the authentication is successful; and an image forming unit that forms an image on a recording medium based on the acquired image data.

### BRIEF DESCRIPTION OF THE DRAWINGS

Exemplary embodiments of the present invention will be described in detail based on the following figures, wherein:

FIG. 1 is a block diagram illustrating an example of the configuration of an image forming system; and

FIG. 2 is a sequence diagram illustrating an example of an image forming operation.

### DETAILED DESCRIPTION

Hereinafter, an exemplary embodiment of the present invention will be described with reference to the accompanying drawings.

### EXEMPLARY EMBODIMENT

### 1-1. CONFIGURATION

### 1-1-1. IMAGE FORMING SYSTEM 1

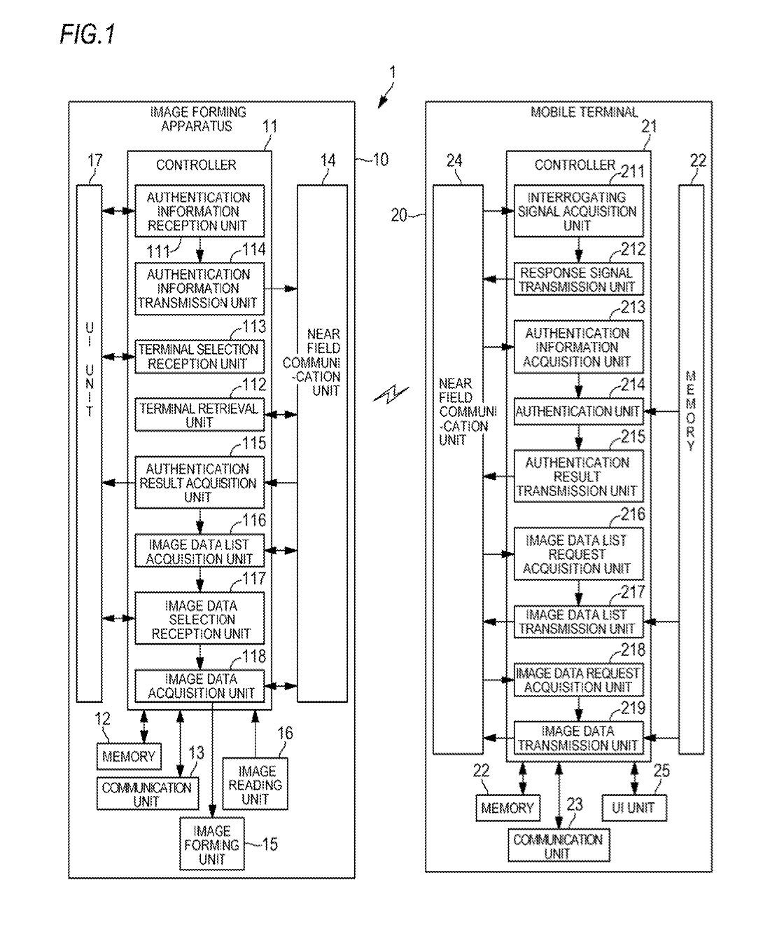

FIG. 1 is a block diagram illustrating an example of the configuration of an image forming system according to an exemplary embodiment of the present invention. The image forming system 1 approximately includes an image forming apparatus 10 and a mobile terminal 20. The image forming apparatus 10 and the mobile terminal 20 perform near field communication. Meanwhile, although only one mobile terminal 20 is illustrated in the drawing, plural mobile terminals 20 may be connected to the image forming apparatus 10 for communication.

### 1-1-2. IMAGE FORMING APPARATUS 10

The image forming apparatus 10 is a device which has a copy function, a scanning function, a printing function, and a facsimile function. The image forming apparatus 10 is installed in, for example, a store, such as a convenience store, and is used by unspecified users. The image forming apparatus 10 includes a controller 11, a memory 12, a communication unit 13, a near field communication unit 14, an image forming unit 15, an image reading unit 16, and a user interface (UI) unit 17.

The controller 11 includes an arithmetic processing unit, such as a central processing unit (CPU), and a memory, and executes a program which is stored in the memory 12. The memory 12 is a storage device, such as a hard disk, and stores the program which is executed by the controller 11. The communication unit 13 is a communication device, such as a data communication card, and transmits and receives data to and from external devices through a communication line, such as the Internet or a wireless local area network (LAN). The near field communication unit 14 is a communication module based on near field communication standards, such as Bluetooth low energy (BLE (registered trademark)), and transmits and receives data to and from the mobile terminal 20. The image forming unit 15 forms an image on a recording medium, such as paper or resin sheet, by an electrophotographic system and an inkjet method. The image reading unit 16 optically reads an image of an original document placed on an original document stand which is not illustrated in the drawing, and outputs the data of the read image to the controller 11. The UI unit 17 includes a display device, such as a liquid crystal display or an organic electro-luminescence (EL) display, and an operation reception device such as a touch sensor or operation keys.

The controller 11 executes the program which is stored in the memory 12, thereby realizing the functions of an authentication information reception unit 111, a terminal retrieval unit 112 a terminal selection reception unit 113, an authentication information transmission unit 114, an authentication result acquisition unit 115, an image data list acquisition unit 116, an image data selection reception unit 117, and an image data acquisition unit 118.

The authentication information reception unit 111 receives authentication information which is input by a user who carries the mobile terminal 20. Here, the authentication information reception unit 111 displays a message, which prompts the user to input the authentication information, on the UI unit 17, and receives the authentication information. The authentication information is input by pressing, for example, the operation keys of the UI unit 17. Otherwise, the authentication information is input by inserting an IC card, which stores the authentication information, into a card reader (which is not illustrated in the drawing) which is included in the image forming apparatus 10. Here, the authentication information is information which is referred to certify the propriety of the user of the mobile terminal 20. More specifically, the authentication information is information which is referred to verify whether or not the user has authority to use image data that is stored in the mobile terminal 20. Specifically, the authentication information is a personal identification number (PIN) code. The PIN code is identification information for identifying the mobile terminal 20.

The terminal retrieval unit 112 searches for the mobile terminal 20 which exists in the vicinity of the image forming apparatus 10 using a near field communication unit 24. Specifically, the terminal retrieval unit 112 searches for the mobile terminal 20 which exists in a communication range by transmitting an interrogating signal within the communication range of the near field communication unit 24 and receiving a response signal from the mobile terminal 20. If a predetermined time elapses after the interrogating signal is transmitted, the terminal retrieval unit 112 determines whether or not the number of mobile terminals 20 is plural. Meanwhile, the response signal, which is received from the mobile terminal 20, includes model information of the terminal.

In case in which plural mobile terminals 20 are found by the terminal retrieval unit 112, the terminal selection reception unit 113 displays a list of the found mobile terminals 20 (hereinafter, referred to as a “terminal list”) on the UI unit 17, and receives an operation of the user to select the mobile terminal 20 of the terminal list. Meanwhile, the model information of each mobile terminal 20 is listed in the terminal list.

The authentication information transmission unit 114 transmits the PIN code, which is received by the authentication information reception unit 111, to the mobile terminal 20. In a case in which only one mobile terminal 20 is found by the terminal retrieval unit 112, the authentication information transmission unit 114 transmits the PIN code to the terminal. In a case in which plural mobile terminals 20 are found by the terminal retrieval unit 112, the authentication information transmission unit 114 transmits the PIN code to the mobile terminals 20 which are selected by the terminal retrieval unit 112 through the terminal selection reception unit 113.

The authentication result acquisition unit 115 acquires authentication result information which is transmitted from the mobile terminal 20. In a case in which the acquired information indicates the failure of the authentication, the authentication result acquisition unit 115 displays a message which indicates the failure of the authentication on the UI unit 17.

In a case in which authentication of the mobile terminal 20 is successful, the image data list acquisition unit 116 acquires a list of image data (hereinafter, referred to as an “image list”) from the mobile terminal 20. Here, the image data list acquisition unit 116 requests transmission of the image list from the mobile terminal 20, and acquires the image list from the mobile terminal 20 in response to the request. Here, specifically, the image data is picture data, and the image list is a picture list.

The image data selection reception unit 117 displays the picture list, which is acquired by the image data list acquisition unit 116 on the UI unit 17, and receives an operation in which the user selects the picture data of the picture list.

The image data acquisition unit 118 acquires the picture data, which is selected through the image data selection reception unit 117, from the mobile terminal 20. Here, the image data acquisition unit 118 requests transmission of the picture data from the mobile terminal 20, and acquires the picture data from the mobile terminal 20 in response to the request. In a case in which the picture data is acquired, the image data acquisition unit 118 outputs the acquired picture data to the image forming unit 15. The image forming unit 15 forms an image on a recording medium based on the acquired picture data.

### 1-1-3. MOBILE TERMINAL 20

The mobile terminal 20 is of mobile-type computer such as a smart phone, a mobile phone, a tablet terminal, or a wearable terminal. The mobile terminal 20 includes a controller 21, a memory 22, a communication unit 23, a near field communication unit 24, and an UI unit 25.

The controller 21 includes an arithmetic processing unit, such as a CPU, and a memory and executes a program which is stored in the memory 22. The memory 22 is a storage device, such as a flash memory, and stores plural pieces of picture data and PIN codes in addition to the program which is executed by the controller 21. The communication unit 23 is a communication device, such as a data communication card, and transmits and receives data with external devices through a communication line, such as the Internet or a wireless LAN. The near field communication unit 24 is a communication module based can near field communication standards, such as BLE, and transmits and receives data to and from the image forming apparatus 10. The UI unit 25 includes a display device, such as a liquid crystal display and an EL display, and an operation reception device such as a touch sensor and operation keys.

The controller 21 realizes the functions of an interrogating signal acquisition unit 211, a response signal transmission unit 212, an authentication information acquisition unit 213, an authentication unit 214, an authentication result transmission unit 215, an image data list request acquisition unit 216, an image data list transmission unit 217, an image data request acquisition unit 218, and an image data transmission unit 219 by executing the program which is stored in the memory 22.

The interrogating signal acquisition unit 211 acquires an interrogating signal which is transmitted from the image forming apparatus 10.

In a case in which the interrogating signal is acquired by the interrogating signal acquisition unit 211, the response signal transmission unit 212 transmits a response signal to the image forming apparatus 10. The response signal includes the model information of the mobile terminal 20.

The authentication information acquisition unit 213 acquires the PIN code transmitted from the image forming apparatus 10. The acquired PIN code is a PIN code which is input to the image forming apparatus 10 by a user who carries the mobile terminal 20.

The authentication unit 214 collates the PIN code, which is acquired by the authentication information acquisition unit 213, and the PIN code, which is stored in the memory 22, and performs user authentication.

The authentication result transmission unit 215 transmits authentication result information, which indicates the result of authentication performed by the authentication unit 214, to the image forming apparatus 10.

In a case in which the authentication performed by the authentication unit 214 is successful, the image data list request acquisition unit 216 acquires a picture list transmission request which is transmitted from the image forming apparatus 10.

In a case in which the picture list transmission request is acquired by the image data list request acquisition unit 216, the image data list transmission unit 217 transmits a picture list, which is a list of plural pieces of picture data stored in the memory 22, to the image forming apparatus 10.

In a case in which the authentication performed by the authentication unit 214 is successful, the image data request acquisition unit 218 acquires a picture data transmission request which is transmitted from the image forming apparatus 10.

In a case in which the picture data transmission request is acquired by the image data request acquisition unit 218, the image data transmission unit 219 transmits the picture data, which is stored in the memory 22, to the image forming apparatus 10, and causes the image forming apparatus 10 to form an image on the recording medium based on the picture data.

### 1-2. Operation

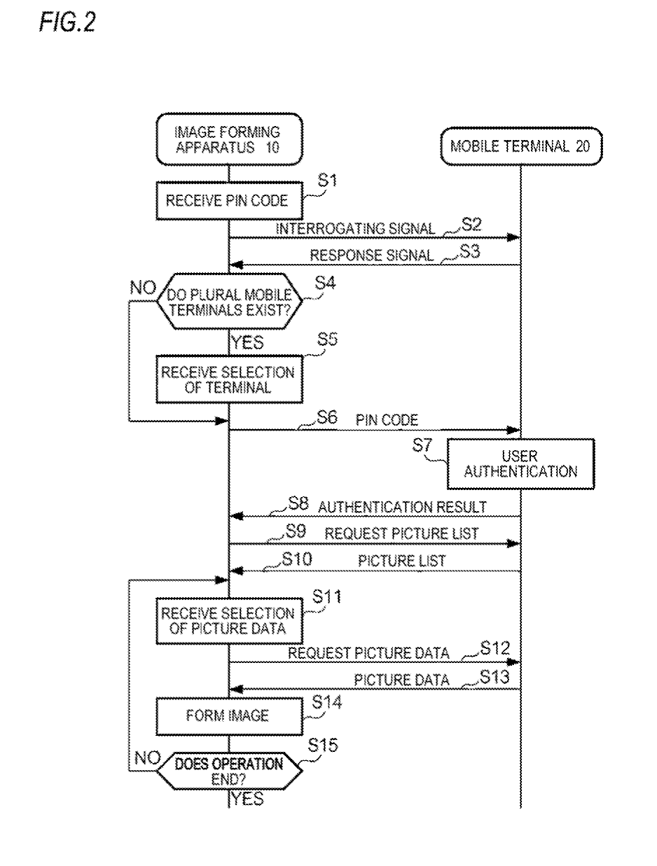

An operation of the image forming system 1 will be described. FIG. 2 is a sequence diagram illustrating an example of an image forming operation which is performed by the image forming system 1.

The authentication information reception unit 111 of the image forming apparatus 10 receives a PIN code which is input by a user who carries the mobile terminal 20 (S1). Here, the authentication information reception unit 111 displays a message which prompts the user to input the PIN code, on the UI unit 17, and receives the PIN code.

In a case in which the PIN code is received, the terminal retrieval unit 112 searches for the mobile terminal 20, which exists in the vicinity of the image forming apparatus 10, using the near field communication unit 24. Specifically, the terminal retrieval unit 112 transmits an interrogating signal within the communication range of the near field communication unit 24 (S2).

The interrogating signal acquisition unit 211 of the mobile terminal 20 acquires the interrogating signal which is transmitted in step S2. In a case in which the interrogating signal is acquired by the interrogating signal acquisition unit 211, the response signal transmission unit 212 transmits a response signal to the image forming apparatus 10 (S3).

The terminal retrieval unit 112 of the image forming apparatus 10 receives the response signal which is transmitted in step S3. In a case in which predetermined time elapses after the interrogating signal is transmitted, the terminal retrieval unit 112 determines whether or not the number of found mobile terminals 20 is plural (S4). In a case in which only one mobile terminal 20 is found as a result of the determination (NO m S4), the authentication information transmission unit 114 transmits the PIN code, which is received in step S1, to the terminal (S6). In contrast, in a case in which plural mobile terminals 20 are found as the result of the determination (YES in S4), the terminal selection reception unit 113 displays a terminal list on the UI unit 17, and receives an operation of selecting a mobile terminal 20 in the terminal list by the user (S5). In a case in which the mobile terminal 20 is selected by the user, the authentication information transmission unit 114 transmits the PIN code, which is received in step S1, to the mobile terminal 20 which is selected in step S5 (S6):

The authentication information acquisition unit 213 of the mobile terminal 20 acquires the PIN code which is transmitted in step S6. In a case in which the PIN code is acquired by the authentication information acquisition unit 213, the authentication unit 214 collates the acquired PIN code and the PIN code, which is stored in the memory 22, and performs user authentication (S7). In a case in which the user authentication is performed, the authentication result transmission unit 215 transmits authentication result information, which indicates the result of authentication performed in step S7, to the image forming apparatus 10 (S8).

The authentication result acquisition unit 115 of the image forming apparatus 10 acquires the authentication result information which is transmitted in step S8. In a case in which the authentication result information indicates the failure of authentication, the authentication result acquisition unit 115 displays a message, which notifies the failure of authentication, on the UI unit 17, and the operation ends (not illustrated in the drawing). In contrast, in a case in which the authentication result information indicates success in authentication, the image data list acquisition unit 116 requests the mobile terminal 20 to transmit a picture list (S9).

The image data list request acquisition unit 216 of the mobile terminal 20 acquires the picture list transmission request which is transmitted in step S9. In a case in which the picture list transmission request is acquired by the image data list request acquisition unit 216, the image data list transmission unit 217 transmits the picture list, which is a list of plural pieces of picture data stored in the memory 22, to the image forming apparatus 10 (S10).

The image data list acquisition unit 116 of the image forming apparatus 10 acquires the picture list which is transmitted in step S10. In a case in which the picture list is acquired by the image data list acquisition unit 116, the image data selection reception unit 117 displays the acquired picture list on the UI unit 17, and receives an operation of selecting picture data in the picture list by the user (S11). In a case in which the picture data is selected by the user, the image data acquisition unit 118 requests the mobile terminal 20 to transmit the selected picture data (S12).

The image data request acquisition unit 218 of the mobile terminal 20 acquires the picture data transmission request which is transmitted in step S12. In a case in which the picture data transmission request is acquired by the image data request acquisition unit 218, the image data transmission unit 219 transmits the picture data, which is stored in the memory 22, to the image forming apparatus 10 (S13).

The image data acquisition unit 118 of the image forming apparatus 10 acquires the picture data which is transmitted in step S13. In a case in which the picture data is acquired, the image data acquisition unit 118 outputs the acquired picture data to the image forming unit 15. The image forming unit 15 forms an image on the recording medium based on the acquired picture data (S14). In a case in which the user instructs to end the operation by operating the UI unit 17 after the image is formed (YES in S15), the operation ends. In contrast, in a case in which the user instructs to continue the operation by operating the UI unit 17 (NO in S15), the process returns to step S11, and the image data selection reception unit 117 displays the picture list on the UI unit 17.

Hereinabove, the image forming operation is described.

According to the above-described image forming system 1, in a case in which authentication of the user of the mobile terminal 20 is performed, it is not necessary to register authentication information in the image forming apparatus 10 in advance. In addition, in a case in which an image is formed based on the picture data stored in the mobile terminal 20, it is not necessary to operate the mobile terminal 20. That is, it is not necessary to take the mobile terminal 20 out of a bag or a pocket intentionally. In addition, compared to a related-art image forming system in which user authentication is performed on a server, the sever is not necessary, and thus the purchasing cost or the managing cost of the sever is not necessary.

### 2. MODIFICATION EXAMPLE

The above-described exemplary embodiment may be modified as follows. In addition, modification examples below may be combined with one or more modification examples.

### 2-1. MODIFICATION EXAMPLE 1

The PIN code according to the exemplary embodiment is an example of the authentication information. Biometric information may be used instead of the PIN code. Specifically, biometric information, such as fingerprints, voiceprints, iris, or impression, which indicates physical features, or biometric information, such as handwriting, which indicates behavioral features, may be used.

### 2-2. MODIFICATION EXAMPLE 2

The picture data according to the exemplary embodiment is an example of the image data. An image may be formed based on image data, which expresses a document, instead of the picture data.

### 2-3. MODIFICATION EXAMPLE 3

In the image forming operation according to the exemplary embodiment, the authentication result information is once transmitted to the image forming apparatus 10 (S8) after the user authentication is performed in the mobile terminal 20, the image forming apparatus 10 requests the mobile terminal 20 to transmit the picture list (S9), and then the picture list is transmitted from the awhile terminal 20 to the image forming apparatus 10 (S10). However, in a case in which the authentication is successful after the user authentication is performed, the mobile terminal 20 may transmit the picture list to the image forming apparatus 10 without transmitting the authentication result information. That is, steps S8 and S9 may be omitted in the image forming operation.

### 2-4. MODIFICATION EXAMPLE 4

In the image forming operation according to the exemplary embodiment, the picture list is once transmitted from the mobile terminal 20 to the image forming apparatus 10 (S10), thereafter the picture data transmission rawest is provided from the image forming apparatus 10 to the mobile terminal 20 (S12), and the picture data is supplied from the mobile terminal 20 to the image forming apparatus 10 (S13). However, in a case in which the amount of the picture data stored in the mobile terminal 20 is relatively small, the mobile terminal 20 may transmit the respective picture data, together with the picture list, to the image forming apparatus 10. That is, steps S12 and S13 may be omitted in the image forming operation.

### 2-5. MODIFICATION EXAMPLE 5

In a case in which the image data list acquisition unit 116 of the image forming apparatus 10 according to the exemplary embodiment requests the mobile terminal 20 to transmit the picture list, the image data list acquisition unit 116 may designate the conditions of the picture data which is published in the list. That is, the image data list acquisition unit 116 may acquire the list of the plural pieces of picture data, which satisfy a predetermined condition, from the mobile terminal 20. Here, the picture data, which satisfy a predetermined condition, is for example, picture data which is generated in a predetermined period. In addition, the picture data is picture data which is associated with a predetermined keyword (tag). The condition may be designated by the user before the image forming apparatus 10 requests the mobile terminal 20 to transmit the picture list.

### 2-6. MODIFICATION EXAMPLE 6

Although the image forming apparatus 10 according to the exemplary embodiment has the copy function, the scanning function, the printing function, and the facsimile function, the image forming apparatus 10 does not necessarily have all of the functions. The functions other than the printing function may be omitted.

### 2-7. MODIFICATION EXAMPLE 7

The programs which are executed by the controller 21 of the image forming apparatus 10 and the controller 21 of the mobile terminal 20 according to the exemplary embodiment may be provided after being stored in a storage medium such as a magnetic tape, a magnetic disk, a flexible disk, an optical disk, a magnetooptical disc, and a memory. In addition, the program may be downloaded through a communication line such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising;
an authentication information reception unit that receives authentication information which is input by a user;
an authentication information transmission unit that transmits the received authentication information to a mobile terminal of the user;
an image data acquisition unit that allows the mobile terminal to perform authentication by collating the transmitted authentication information and authentication information, which is stored in the mobile terminal, and acquires image data from the mobile terminal in a case in which the authentication is successful; and
an image forming unit that forms an image on a recording medium based on the acquired image data.

2. The image forming apparatus according to claim 1, further comprising:
an image data list acquisition unit that, in a case in which the authentication is successful, acquires a list of a plurality pieces of image data from the mobile terminal; and
image data selection reception unit that displays the acquired list on a display, and receives an operation of selecting the image data in the list by the user,
wherein the image data acquisition unit acquires the selected image data from the mobile terminal.

3. The image forming apparatus according to claim 1,
wherein the authentication information is identification information for identifying the mobile terminal.

4. A mobile terminal comprising:
an authentication information acquisition unit that acquires authentication information, which is input by a user of the mobile terminal, from an image forming apparatus which forms an image on a recording medium based in image data;
an authentication unit that performs authentication by collating the acquired authentication information and authentication information which is stored in the mobile terminal; and
an image data transmission unit that, in a case which the authentication is successful, transmits image data, which is stored in the mobile terminal, to the image forming apparatus, and causes the image forming apparatus to form an image on the recording medium based on the image data.

5. An image forming system comprising:
an image forming apparatus comprising:
an authentication information reception unit that receives authentication information which is input by a user;
an authentication information transmission unit that transmits the received authentication information to a mobile terminal of the user;
an image data acquisition unit that allows the mobile terminal to perform authentication by collating the transmitted authentication information and authentication information, which is stored in the mobile terminal, and acquires image data from the mobile terminal in a case in which the authentication is successful; and
an image forming unit that forms an image on a recording medium based on the acquired image data, and
a mobile terminal comprising:
an authentication information acquisition unit that acquires authentication information, which is input by a user of the mobile terminal, from an image forming apparatus which forms an image on a recording medium based on image data;
an authentication unit that performs authentication by collating the acquired authentication information and authentication information which is stored in the mobile terminal; and
an image data transmission unit that, in a case in which the authentication is successful, transmits image data, which is stored in the mobile terminal, to the image forming apparatus, and causes the image forming apparatus to form an image on the recording medium based on the image data.

6. A non-transitory computer readable medium storing a program causing computer to execute a process, the process comprising:
receiving authentication information which is input by a user;
transmitting the received authentication information to a mobile terminal of the user;
performing authentication by allowing the mobile terminal to collate the transmitted authentication information and authentication information, which is stored in the mobile terminal, and acquiring image data from the mobile terminal in a case in which the authentication is successful; and
forming an image on a recording medium based on the acquired image data.
